(19) United States
(12) Patent Application Publication
(10) Pub. No.: US 2004/0215457 A1
(43) Pub. Date: Oct. 28, 2004

(54) Selection of alternative word sequences for discriminative adaptation

(76) Inventor: Carsten Meyer, Aachen (DE)

Correspondence Address: PHILIPS INTELLECTUAL PROPERTY & STANDARDS, P.O. BOX 3001, BRIARCLIFF MANOR, NY, 10510, US

(21) Appl. No.: 09/982,285

(22) Filed: Oct. 17, 2001

(30) Foreign Application Priority Data
Oct. 17, 2000 (DE) 10051527.4

(51) Int. Cl. G10L 15/04

(52) U.S. Cl. 704/251

(57) ABSTRACT

The invention relates to a method for the discriminative adaptation of reference models of a pattern recognition system, in particular of acoustic reference models of a speech recognition system, wherein, starting from a quantity of given patterns whose classification is known in each case or is estimated, and starting from given reference models,

a first scored classification is generated for one of the given patterns through the use of the given reference models,

if said first classification differs from the known or estimated classification, said first classification is assigned as an alternative classification to the known or estimated classification,

if not, a second scored classification is generated for the given pattern with the use of the given reference models and, provided the difference between the scores of the first and second classifications is smaller than a first threshold value, said second classification is assigned as an alternative classification to the known or estimated classification,

an adaptation of at least one of said given reference models is carried out with the use of the assignation/assignations thus determined.

The invention relates to a method for the discriminative adaptation of reference models of a pattern recognition system, in particular of acoustic reference models of a speech recognition system.

Pattern recognition methods are generally used in automatic speech recognition, i.e. in the machine-based conversion of spoken language into written text. That is to say that the actually spoken word sequence of an unknown speech signal is determined in that the components of the unknown speech signal are compared with stored reference models. These stored reference models are obtained usually in a preparatory training step, i.e. the reference models result from the implementation of a training procedure which usually presupposes the existence of a quantity of given acoustic speech signals of which the associated spoken word sequences are known in all cases.

The training procedure generally has the result that the reference models encode inter alia a certain amount of information on the acoustic structure of a language, for example also about the individual sounds of the language. This part of the reference models is accordingly denoted the acoustic reference models, or acoustic models for short. In addition, further characteristics of a language or of a certain portion of a language can be trained in various situations. Examples of this are statistical properties relating to word order, or models relating to the grammatical structure of sentences. Such properties may be contained, for example, in so-called language models (as opposed to the acoustic models).

The so-called maximum likelihood training may be used for training the acoustic reference models. The parameters of the reference models are estimated in such a manner that the relative likelihoods:

P(Xᵣ\W)

(Xᵣ: speech signal, W: associated spoken word sequence, P(Xᵣ\W): relative likelihood of Xᵣ, given W, resulting from the acoustic reference model), i.e. the likelihoods that the actually spoken word sequences generate the acoustic speech signals, are maximized. Furthermore, discriminative training methods are used, which are usually based on acoustic reference models already present, which methods are (pre)trained, for example, in accordance with the maximum likelihood method.

Methods for the discriminative training of the acoustic reference models are known, for example, from the conference paper “Schlütter, R., Macherey, W., Müller, B., and Ney, H.,: A Combined Maximum Mutual Information and Maximum Likelihood Approach for Mixture Density Splitting, Proc. EUROSPEECH-99, pp. 1715-1718, Budapest, Hungary, 1999”. The authors give a standardized presentation of various known discriminative training methods therein.

In this presentation, it is common to the discriminative training methods discussed that they attempt to optimize the discrimination between the actually spoken word sequence (spoken words Wᵣ) and a quantity of alternative word sequences (set of alternative word sequences Mᵣ). The actually spoken word sequence (Wᵣ) is presupposed to be known. The alternative word sequences are word sequences which show a “certain similarity” to the spoken word sequence. The actually spoken word sequence may itself also be an element of the set of alternative word sequences in some discriminative methods.

A possibility of obtaining such a quantity of alternative word sequences (Mᵣ) for a speech signal in addition to the known spoken word sequence consists in that a recognition step is carried out. A speech recognition system is used for this which supplies not only a word sequence (“the recognized word sequence”), but a plurality of different word sequences. This plurality may be formed, for example, by a so-called N-best list, or alternatively of a so-called word graph. All word sequences in said plurality are to be regarded as a possible recognition result, i.e. they are hypothetical candidates for the spoken word sequence, for which reason this plurality is referred to as candidate plurality hereinafter. This candidate plurality then forms a possible choice for the set of alternative word sequences (Mᵣ).

It is also possible for the generation of the candidate plurality to use a speech recognition system which in addition supplies a real number for each word sequence of the candidate plurality, which number is denoted the score of the word sequence hereinafter, and which number indicates a relative ranking of the candidate word sequences in the sense that the candidate word sequence with the best score would be chosen as the “recognized word sequence”. The candidate word sequence with the second best score would accordingly be the second candidate for the recognized word sequence, which could be, for example, used as the next one if the user in a dialogue system should reject as incorrect the word sequence proposed first and having the best score.

Speech recognition systems are often used in practice which utilize the negative logarithm of the relative likelihood (negative log likelihood or negative log probability) that the candidate word sequence belongs to the speech signal to be recognized: −log P(W\Xᵣ)

(log: logarithmic function, W: candidate word sequence, Xᵣ: speech signal, P(W\Xᵣ): relative likelihood of W, given Xᵣ). The likelihood P(W\Xᵣ) is not the actual likelihood, which will usually not be known, but the likelihood resulting from the reference models.

It was found to be favorable to use a speech recognition system for the generation of the candidate plurality which supplies exactly such a score for each candidate plurality, and then to control the generation of the candidate plurality such that those candidate word sequences having the best possible scores are generated from among all possible word sequences. Suitable procedures for limiting the search within the possible word sequences are used for this (pruning). N-best search procedures are also used in part.

In the conference paper by Schlüter et al., the differences of the discriminative training methods presented therein are based on the following characteristics:

the selection of the plurality of the alternative word sequences (Mᵣ),

weighting of the score relationships of the word sequences (Schlüter et al. use the logarithm and probabilities powered by an exponent α), and

smoothing of the weighted score relationships of the individual acoustic speech signals of the training material (smoothing function ƒ).

It is useful for the understanding of the present invention to study in particular the two discriminative training methods proposed by Schlüter et al., i.e. the corrective training (CT) and falsifying training (FT). These two methods each utilize exactly one alternative word sequence from the plurality of alternative word sequences (Mᵣ), which is why they are less complicated than the other methods proposed by Schlüter et al., which (at least potentially) each use more than one word sequence from among the plurality of alternative word sequences (Mᵣ).

The falsifying training here has the advantage over the corrective training that it utilizes the quantity of training material of given acoustic speech signals better in that it also uses the correctly recognized acoustic speech signals for training the acoustic reference models, whereas the corrective training utilizes only the incorrectly recognized signals. This usually leads to a better estimation of the acoustic reference models, i.e. speech recognition systems operating with acoustic reference models obtained from falsifying training as a rule have lower error rates in recognition than those which use acoustic reference models obtained from corrective training.

This advantage of the falsifying training method over the corrective training method, however, involves some practical disadvantages. A smoothing function (ƒ) is used which can only be optimized in experiments, and the complexity of the method is increased thereby. Furthermore, the quantity of calculation work in training of the acoustic reference models is increased by the use of all acoustic speech signals from the quantity of given acoustic speech signals.

It is accordingly an object of the invention to provide a method of the kind mentioned in the opening paragraph in which the set of alternative word sequences (Mᵣ) always consists of exactly one alternative word sequence, and which utilizes the quantity of training material of the given acoustic speech signals effectively, but which has a lower complexity and requires less calculation work than does the falsifying training.

This object is achieved by a method as defined in claim 1.

The basic idea of the method defined in claim 1 is that, in addition to the incorrectly recognized acoustic speech signals from the quantity of given acoustic speech signals, also those correctly recognized signals are utilized which contribute considerably to an improvement of the training of the acoustic reference models. In contrast to falsifying training, however, a smoothing function is not necessarily used, and neither are all correctly recognized acoustic speech signals necessarily used. Instead, a first threshold value is used for selecting the correctly recognized acoustic speech signals for which an assignment of an alternative word sequence to the spoken word sequence of the acoustic speech signal takes place.

Briefly, it is assumed in the above paragraph that the first and possibly also the second word sequence generated for a given speech signal was generated by a recognition step, which is why mention is made of correctly recognized and incorrectly recognized acoustic speech signals. The invention, however, is not limited to the implementation of such a recognition step, but it relates to all generating processes.

Furthermore, the invention is not limited to the idea that the adaptation of the acoustic reference models takes place by means of a discriminative training step. It also covers all other embodiments which utilize the assignments of the respective alternative word sequence according to the invention for adapting the reference models. Among these are, for example, also discriminative adaptation processes. In these adaptation processes, the quantity of training material of the given acoustic speech signals is also denoted the adaptation material.

It is specified in dependent claim 2 that only the assignments explicitly provided in claim 1 are used for adapting the acoustic reference models.

The dependent claims 3 to 6 relate to modifications of the invention which reduce the quantity of training material of the given acoustic speech signals through the use of a second threshold value, which indicate methods of determining the first and the second threshold value, and which utilize the previously described methods for adapting the acoustic reference models as building boxes in an iterative cycle usual for the discriminative adaptation. A complete adaptation method is obtained in this manner for acoustic reference models, which method is simpler and requires less calculation time than the known falsifying training.

Whereas it was assumed in the preceding claims that the respective spoken word sequence of given acoustic speech signals was known, the invention in claim 7 relates to the case in which the spoken word sequence is not known, but is estimated (unsupervised adaptation). With this estimated word sequence replacing the spoken word sequence, all previously denoted methods can be carried out while remaining otherwise unchanged. A speech recognition system may be used, for example, for estimating the unknown spoken word sequence.

In claim 8, however, the invention relates to the reference models themselves, which models were generated by means of one of the above methods of discriminative adaptation of these models, and it relates to a data carrier storing such models in claim 9, and to a speech recognition system utilizing such models in claim 10.

In claim 11, the invention is applied to the discriminative adaptation of the reference models of general pattern recognition systems, of which the speech recognition system discussed above is a special case.

In claim 12, the invention relates to the reference models themselves, which models were generated by means of one of said methods of discriminative adaptation of these models, in claim 13 it relates to a data carrier storing such models, and in claim 14 to a pattern recognition system utilizing such models.

These and further aspects and advantages of the invention will be explained in more detail below with reference to the embodiments and in particular with reference to the appended drawings, in which:

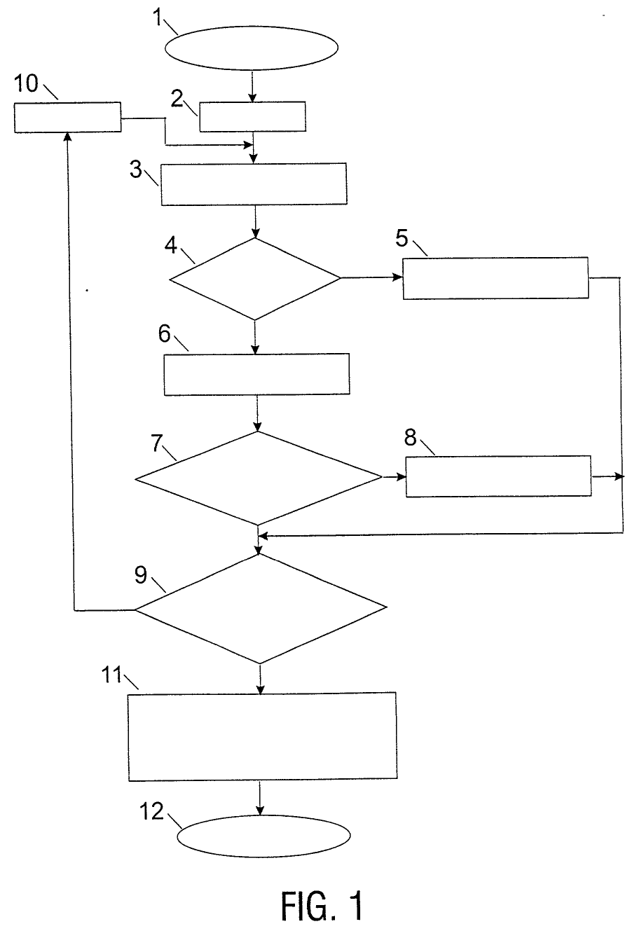

FIG. 1 shows an embodiment of the method according to the invention for the discriminative adaptation of acoustic reference models of a speech recognition system as claimed in claim 1,

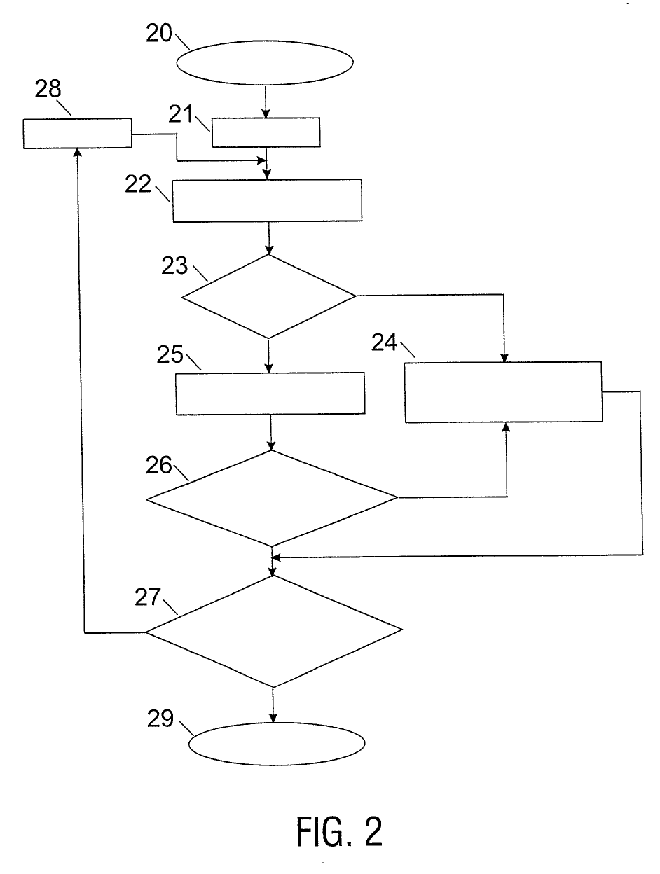

FIG. 2 shows an embodiment of the limitation of the quantity of given acoustic speech signals according to the invention, i.e. according to the characterizing part of claim 3,

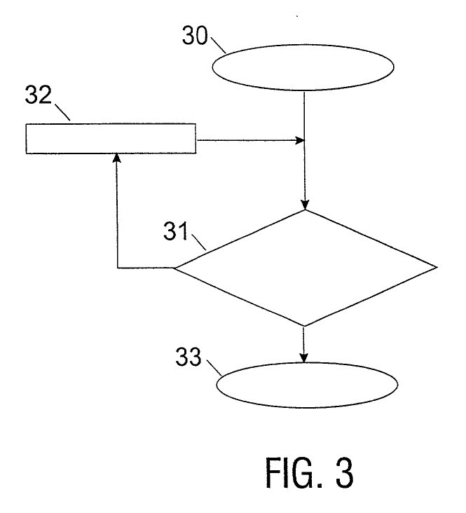

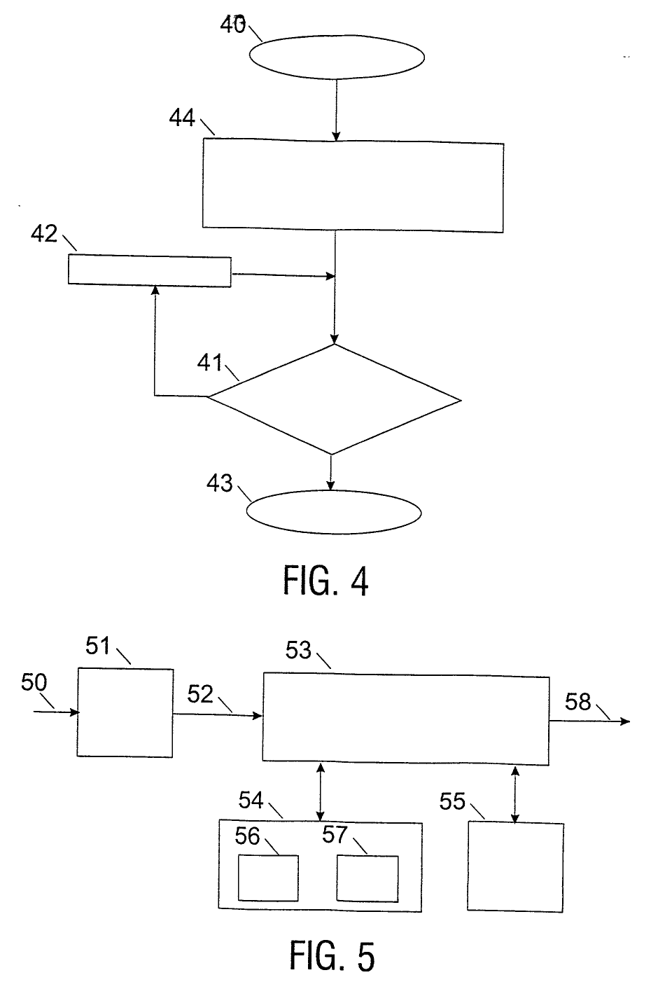

FIGS. 3 and 4 show modified embodiments according to the invention of iterative methods as claimed in claim 6, and

FIG. 5 shows an embodiment of a speech recognition system as claimed in claim 10.

FIG. 1 shows an embodiment of the method according to the invention for the discriminative adaptation of acoustic reference models of a speech recognition system as claimed in claim 1 in the form of a flowchart.

The method starts in box 1 and then moves to box 2. In box 2, a counter variable r is given the initial value 1: r←1. Then the control is surrendered to box 3, where a first scored word sequence W¹ᵣ and its score b¹ᵣ are generated for the r^{th} acoustic speech signal from the quantity of given acoustic speech signals through the use of the given acoustic reference models. Then the control moves to decision box 4. There the first word sequence W¹ᵣ is compared with the spoken word sequence Wᵣ belonging to the r^{th} acoustic speech signal.

If the first word sequence W¹ᵣ and the spoken word sequence Wᵣ are different: W¹ᵣ≠Wᵣ, then the control will move to box 5, where the first word sequence W¹ᵣ is assigned as an alternative word sequence to the spoken word sequence Wᵣ:W^{a}ᵣ←W¹ᵣ, whereupon the control moves on to box 9. If the first word sequence W¹ᵣ and the spoken word sequence Wᵣ are identical, however: W¹ᵣ=Wᵣ, then the control moves from box 4 to box 6, where the second scored word sequence W²ᵣ and its score b²ᵣ are generated, whereupon the control moves on to box 7. In box 7, the score difference between the first and the second word sequence is compared with a first threshold value s₁. If the score difference is smaller than this first threshold value: b²ᵣ−b¹ᵣ<s₁, then the control moves to box 8, where the second word sequence W²ᵣ is assigned as an alternative word sequence to the spoken word sequence Wᵣ: W^{a}ᵣ, whereupon the control moves further to box 9. If this score difference, however, is greater than or equal to said first threshold value: b²ᵣ−b¹ᵣ≧s₁, then the control moves directly from box 7 to box 9.

It is tested in box 9 whether the r^{th} acoustic speech signal was the final one from the quantity of given acoustic speech signals, i.e. whether all given acoustic speech signals have been dealt with in the implementation of the method. If this is not the case, the control goes to box 10, where the counter variable r is incremented by 1: r←r+1, whereupon the control starts again in box 3. If all given acoustic speech signals had been dealt with, however, the control goes to box 11, where the adaptation of the given acoustic reference models under treatment is carried out with the use of the assignments W^{a}ᵣ thus determined. The control then goes to box 12, in which the method is concluded.

The generation of the first and second scored word sequences W¹ᵣ and W²ᵣ in boxes 3 and 6, respectively, preferably takes place through a recognition step with the use of the given acoustic reference models. Any recognition method known to those skilled in the art may be used for this, said method having for its object to find those word sequences which have the best possible scores for a given acoustic speech signal.

It is then quite possible that several different word sequences are found with the same score for a given acoustic speech signal. It is also possible, however, that only one, or even no word sequence at all is found on the basis of the conventionally used methods for limiting the amount of search work in the recognition (pruning).

It is favorable for the method according to the invention to use a recognition method which within the framework of its possibilities supplies besides the word sequence with the best score also a word graph which implicitly contains the best word sequences as regards their scores together with their scores in a compact manner. The word sequences with their scores may then be explicitly obtained from such a word graph with comparatively little work involved (see, for example, B. H. Tran, F. Seide, V. Steinbiss: A word graph based N-best search in continuous speech recognition, Proc. ICSLP '96, Philadelphia, Pa., pp. 2127-2130). It is not necessary here that the recognition method used finds the word sequences with the actually best scores, but it suffices when it does this approximatively in a manner known to those skilled in the art.

Advantageously, the word sequence having the best score directly supplied by the recognition method is taken as the first scored word sequence W¹ᵣ. If there are several different word sequences with the same best score, any of these may be taken to be the first scored word sequence W¹ᵣ. Usually, the recognition method carries out this selection, because it generates the word sequences in a certain order anyway on the basis of its internal structure.

The second scored word sequence W²ᵣ is advantageously extracted as the second best word sequence from the word graph supplied by the recognition method. If there are several different word sequences with the same best score, then the first and the second scored word sequence W¹ᵣ and W²ᵣ will have the same numerical value as their score. It should then be noted in the implementation of the extraction method that a word sequence different from the first scored word sequence is generated as the second scored word sequence: W²ᵣ≠W¹ᵣ. This may be achieved, for example, through a suitable arrangement of the extraction method (cf. the cited paper by Tran et al.).

It should always be noted in the generation of the second scored word sequence W²ᵣ that it is different from the first scored word sequence W¹ᵣ: W²ᵣ≠W¹ᵣ. It may thus arise in the case of homophones under certain conditions that two word sequences W¹ and W² are (acoustically) identical: W¹=W², whereas their associated scores b¹ and b² are different: b¹≠b². If this case should arise in the second best word sequence supplied by the recognition method, the respective next best word sequence should be generated repeatedly by the recognition method until the first word sequence different from the first scored word sequence W¹ᵣ is obtained so as to serve as the second scored word sequence W²ᵣ.

If no word sequence at all could be generated for the given acoustic speech signal in the recognition step, for example because of pruning, this speech signal is ignored as far as the method of FIG. 1 is concerned. If the first scored word sequence W¹ᵣ could be generated, it is possible in certain circumstances that the second scored word sequence W²ᵣ cannot be generated, for example if the word graph contains no further word sequences. In this case, this speech signal will only be utilized if the first scored word sequence differs from the associated spoken word sequence: W¹ᵣ≠Wᵣ, i.e. if the generation of the second scored word sequence W²ᵣ is unnecessary. Otherwise, this speech signal will also be ignored. These special cases are not shown in FIG. 1 for simplicity's sake. The embodiment of the invention shown in FIG. 1, however, is to be regarded as including these special cases.

The negative logarithm of the relative probability, −log P(W\Xᵣ), mentioned above may be used as the score of a word sequence W. Several recognition methods, however, also use quantities as scores which do indeed show a close relationship to this negative logarithm but do not exactly correspond thereto. Further possibilities are the confidence intervals known from the literature. All these valuations represent scores in the sense of the invention. If such a negative logarithm is used as the score, the difference between these scores: b²ᵣ−b¹ᵣ, may be used as the difference between the scores of the first and second word sequences W¹ᵣ and W²ᵣ, which was assumed in the discussion of box 7 of FIG. 1.

Only the previously determined assignments of the alternative word sequences W^{a}ᵣ to the spoken word sequences Wᵣ are used in the adaptation of the relevant acoustic reference models in box 11. The given acoustic speech signals for which the first word sequence corresponds to the associated spoken word sequence: W¹ᵣ=Wᵣ, and for which the difference between the scores of the first and the second word sequence is greater than or equal to the first threshold value: b²ᵣ−b¹ᵣ≧s₁, are ignored in the adaptation. Equally ignored, as was stated above, are those speech signals for which the first scored word sequence cannot be generated at all, or for which the second scored word sequence cannot be generated while the first word sequence corresponds to the spoken word sequence (W¹ᵣ=Wᵣ). Instead of fully ignoring the speech signals thus qualified in the adaptation, there is in principle also the possibility to use them for the adaptation after all in that for them the respective necessary assignment of the quantity of alternative word sequences is obtained by a method other than the method according to the invention.

The adaptation step carried out in box 11 involves a discriminative new estimation of the given acoustic reference models. Depending on how these reference models were actually selected (for example whole-word or phoneme models), and depending on which assignments were calculated previously, it is possible that several of these reference models do not appear in any of said assignments, i.e. said reference models occur neither in one of the spoken word sequences Wᵣ of the non-ignored speech signals, nor in one of the associated alternative word sequences W^{a}ᵣ. There is then the possibility of omitting these reference models in the adaptation step, i.e. to allow these reference models to remain in their old form.

The remaining reference models “observed” in this sense may be estimated anew by one of the discriminative estimation methods known to those skilled in the art, i.e. the newly determined reference models take the place of the given reference models valid up to that moment. In this new estimate, the spoken word sequence Wᵣ is to be discriminated from the previously assigned alternative word sequence W^{a}ᵣ. In the terminology of the cited paper by Schlüter et al., set of alternative word sequences Mᵣ is formed exactly by the alternative word sequence W^{a}ᵣ.

Discriminative estimation methods particularly eligible within the framework of the invention are now also the simple versions of these methods. Thus, in the terminology of Schlüter et al., the identity function may simply be chosen as the smoothing function (ƒ), as is the case in the corrective training (CT). Obviously, the choice of the sigmoid function is also possible, as is the case in the falsifying training (FT).

Where the reference models not taken into account in the adaptation step shown in box 11 are not adapted in this embodiment, it is also conceivable to adapt these reference models as well, for example in a smoothing step. Among the methods known from the literature in this respect is, for example, the vector field smoothing method.

In a further embodiment of the invention, it is provided that the adaptation step shown in box 11 is carried out not as a discriminative new estimation, but as a discriminative adaptation of the acoustic reference models. Several methods of adapting acoustic reference models are known from the literature, i.e. for adapting the reference models to new data such as, for example, a new speaker or a new channel. An example is the so-called MLLR method (Maximum Likelihood Linear Regression), which optimizes a maximum likelihood criterion, the basic idea of which may nevertheless be transferred also to the optimization of a discriminative criterion. Such a discriminative adaptation method is known, for example, from the publication “F. Wallhoff, D. Willett, G. Rigoll, Frame Discriminative and Confidence-Driven Adaptation for LVCSR in IEEE Intern. Conference on Acoustics, Speech, and Signal Processing (ICASSP), Istanbul, Turkey, June 2000”.

FIG. 2 shows an embodiment of the limitation of the quantity of given acoustic speech signals according to the invention in the form of a flowchart.

The method starts in box 20, in which the necessary initializations, and in particular the initialization of the new quantity of given acoustic speech signals and their spoken word sequences with respect to the empty quantity (T_{new}←Ø), are carried out, whereupon it moves to box 21. In box 21, a counter variable r is given the initial value 1: r←1. Then the control is given to box 22, where a first scored word sequence W¹ᵣ and its score b¹ᵣ are generated for the r^{th} acoustic speech signal from among the quantity of given acoustic speech signals through the use of the given acoustic reference models. The control then moves on to decision box 23. There the first word sequence W¹ᵣ is compared with the spoken word sequence Wᵣ belonging to the r^{th} acoustic speech signal.

If the first word sequence W¹ᵣ and the spoken word sequence Wᵣ are different: W¹ᵣ≠Wᵣ, the control moves to box 24, in which the r^{th} acoustic speech signal Xᵣ and its associated spoken word sequence Wᵣ are added to the new set: T_{new}←T_{new}∪{(Xᵣ, Wᵣ)}, whereupon the control moves further to box 27. If the first word sequence W¹ᵣ and the spoken word sequence Wᵣ are identical: W¹ᵣ=Wᵣ, the control moves from box 23 to box 25, in which the second scored word sequence W²ᵣ and its score b²ᵣ are generated, whereupon the control goes further to box 26. In box 26, the difference between the scores of the first and second word sequences is compared with a second threshold value s₂. If the score difference is smaller than this second threshold value: b²ᵣ−b¹ᵣ<s₂, the control moves to box 24, in which the r^{th} acoustic speech signal Xᵣ and its associated spoken word sequence Wᵣ are added to the new set: T_{new}←T_{new}∪{(Xᵣ, Wᵣ)}, as described above. Then the control moves on to box 27. If this score difference, however, is greater than or equal to said second threshold value: b²ᵣ−b¹ᵣ≧s₂, the control moves directly from box 26 to box 27.

It is tested in box 27 whether the r^{th} acoustic speech signal was the final one from the quantity of given acoustic speech signals, i.e. whether in the implementation of the method all given acoustic speech signals have already been dealt with. If this is not the case, the control goes to box 28, where the counter variable r is incremented by 1: r←r+1, whereupon the control enters box 22 again. If all given acoustic speech signals have been dealt with, on the other hand, the control finally goes to box 29, in which the new set takes the place of the old set of the given acoustic speech signals, whose spoken word sequences are known in each case: T_{old}←T_{new}, and the process is concluded.

The formation of the new set of given acoustic speech signals as described here and its future use instead of the old set may be realized in various ways as regards storage technology. For example, the new set may first be made from a copy of the speech signals selected from the old set, whereupon the new set is used instead of the old one through switching of a storage indicator. Alternatively, the new set may also be formed as a quantity of indicators pointing to the corresponding speech signals of the old set. Other solutions known to those skilled in the art are equally conceivable.

The common features of the two methods shown can be obtained from a comparison of the two flowcharts of FIGS. 1 and 2. First of all, the statements made with regard to FIG. 1 on the generation of the first and second scored word sequences W¹ᵣ and W²ᵣ and on the nature of the scores and the score difference are equally valid for FIG. 2. It is furthermore obvious that the method of FIG. 2 can be carried out jointly with the method of FIG. 1, because the essential process steps such as, for example, the generation of the first and second word sequences, are identical. This circumstance will be discussed in more detail in the description of FIG. 5 below.

The threshold values s₁ and s₂ used in the above embodiments may be preprogrammed as fixed score differences. They then indicate a decisive number which, when exceeded, causes the second word sequence to be classified generally speaking as of lesser importance compared with the first word sequence.

The absolute value of the score of a word sequence, and to a certain degree therefore also the absolute value of the score difference between two word sequences, however, may differ strongly from one speech signal to another, and may furthermore depend on details of the speech recognition system such as, for example, its lexicon. Accordingly, an alternative possibility for determining said threshold values consists in that a certain number (Q₁ for s₁ and Q₂ for s₂) is preprogrammed for each of them, which number lies between 0 and 1: 0≦Q₁≦1, 0≦Q₂≦1. The threshold values s₁ and s₂ then appear as the Q₁ and Q₂ quantiles of the statistical distribution function of the differences in the scores of the first and second word sequences of those given acoustic speech signals whose first word sequence corresponds to the spoken word sequence. For calculating the quantiles, obviously, only those speech signals can be used for which the speech recognition system supplies both a first and a second word sequence.

The use of this quantile method thus achieves a certain independence of the details of the actually given adaptation situation. Furthermore, a simple and approximately linear control of the calculation process is obtained, because the quantile has an approximately linear relation to the value of that portion of the quantity of given acoustic speech signals which is used for the calculation of the assignments.

To achieve that the control can still be effective in applying the first threshold value s₁ during the use of the second threshold value s₂, s₂ must be chosen to be greater than s₁: s₂>s₁. Accordingly, Q₂ must be chosen to be greater than Q₁: Q₂>Q₁, if the quantile method is used. Such a choice, however, is not necessary for the basic principle of operation of the method.

FIGS. 3 and 4 show modified embodiments of iterative discriminative adaptation methods in which a method according to the invention as claimed in one of the claims 1 to 5 is used as a single iteration step. It is common to the two modified versions that the method as claimed in one of the claims 1 to 5 is repeated until a stop criterion is fulfilled. All possibilities known to those skilled in the art may be used for this stop criterion, for example a given number of iteration steps, or the achieving of a minimum in the error rate in the training material quantity or alternatively a separate validation quantity.

FIG. 3 first shows a simple iteration diagram in the form of a flowchart. The method starts in box 30. The stop criterion is then tested in decision box 31. If this criterion is not fulfilled, a method as claimed in one of the claims 1 to 5 is implemented in box 32, adapting the previously given acoustic reference models in accordance with the invention. An iteration step has been concluded after box 32, and the method returns to box 31. If the stop criterion was fulfilled in box 31, however, the control moves to box 33, in which the method is concluded.

In FIG. 4, this simple iteration diagram is augmented with a box 44 lying upstream of the actual iteration loop, i.e. the boxes 40 to 43 correspond to the boxes 30 to 33 of FIG. 3. The same holds for the transitions between these boxes, with the exception that in FIG. 4 box 44 is moved between the boxes 40 (start) and 41 (testing of the stop criterion).

Box 44 relates to the implementation of a method as claimed in claim 3, i.e. an adaptation of the acoustic reference models is being carried out, for example as shown in FIG. 1. Simultaneously, the given set of acoustic speech signals and their associated spoken word sequences are limited through the use of a second threshold value S2 owing to the combined implementation of a method as shown in FIG. 2. As was mentioned further above, this simultaneous implementation of the methods shown in FIGS. 1 and 2 is possible without problems because of their many points in common.

Only those assignations of alternative word sequences to the spoken word sequences of the given acoustic speech signals which belong to the set limited through the use of the second threshold value s₂ are used in each case in the adaptation of the acoustic reference models in box 44. If the second threshold value is smaller than the first threshold value: s₂<s₁, therefore, it is only the second threshold value s₂ which determines which assignations are used, and the first threshold value s₁ is immaterial.

If one or both of the threshold values s₁ and s₂ are preprogrammed implicitly only through the indication of a respective quantile of the distribution of the corresponding score differences, a single passage through the quantity of training material of the given acoustic speech signals will suffice also in this case for determining the first, and possibly the second word sequence in box 44. The required threshold values s₁ and s₂ will simultaneously result therefrom in an explicit form.

The methods shown in FIGS. 1 and 2 should be modified as follows for this: when working through the quantity of training material, first only the first word sequence W¹ᵣ thereof, the score b¹ᵣ thereof, and possibly (if W¹ᵣ=Wᵣ) the second sequence W²ᵣ and the score b²ᵣ thereof are generated. Furthermore, the assignation of the alternative word sequence to the spoken word sequence is also carried out already: W^{a}ᵣ←W¹ᵣ, in those cases in which the first word sequence differs from the spoken word sequence: W¹ᵣ≠Wᵣ, and this speech signal Xᵣ and its spoken word sequence Wᵣ are included in the new set of the given acoustic speech signals: T_{new}←T_{new}∪{(Xᵣ, Wᵣ)}.

In all other cases, first the second word sequence W²ᵣ and the score difference thereof b²ᵣ−b¹ᵣ are stored only. The desired threshold values s₁ and s₂ can be explicitly obtained as quantiles of the distribution of these score differences from the set of the stored score differences. The assignations of the alternative word sequences still missing may then be obtained from the set of the stored score differences and the stored second word sequences by means of the threshold value s₁: W^{a}ᵣ←W²ᵣ, in as far as b²ᵣ−b¹ᵣ<s₁ (please note: it was true for these stored word sequences that W¹ᵣ=Wᵣ). Furthermore, the further speech signals Xᵣ and their spoken word sequences Wᵣ can be included into the new set of the given acoustic speech signals from the quantity of stored score differences by means of the threshold value s₂: T_{new}←T_{new}∪{(Xᵣ, Wᵣ)}, in as far as b²ᵣ−b¹ᵣ<s₂.

If, unlike the situation assumed above, the spoken word sequence of a given acoustic speech signal of the quantity of training material is not known, the method according to the invention may still be used in a modified form. For this purpose, an estimation of the (unknown) spoken word sequence is made, for example by means of a speech recognition system. This estimated word sequence then takes the place of the (unknown) spoken word sequence. All processes described above can be carried out therewith in otherwise unchanged form. The estimation of the unknown spoken word sequence used may be, for example, also the first scored word sequence W¹ᵣ generated through the use of the given acoustic reference models.

Although the invention was described above in the context of the adaptation of acoustic reference models of a speech recognition system, it is equally applicable to the discriminative adaptation of the reference models of general pattern recognition systems. The reference models of the pattern recognition system take the place of the acoustic reference models of a speech recognition system. The quantity of training patterns whose classification is known in each case or is alternatively estimated takes the place of the quantity of given acoustic speech signals, whose associated spoken word sequences are known in each case or are alternatively estimated. The first and second scored word sequences of a given acoustic speech signal are replaced by the first and second scored classifications of a given training pattern. The assignation of an alternative classification takes the place of the assignation of an alternative word sequence. Given these replacements, the methods claimed for speech recognition systems can be carried out for general pattern recognition systems in an otherwise unchanged form.

FIG. 5 shows the basic structure of a speech recognition system, in particular a dictation system (for example FreeSpeech of the Philips company) as a special case of a general pattern recognition system. A speech signal 50 put in is supplied to a functional unit 51 which carries out a feature extraction for this signal and generates feature vectors 52 which are supplied to a processing or matching unit 53. In the matching unit 53, which determines and provides the recognition result 58, a path search is carried out in a known manner, for which an acoustic model 54 and a language model 55 are used. The acoustic model 54 comprises on the one hand models for word sub-units such as, for example, triphones which are associated with acoustic reference models 56, and a lexicon 57 which represents the vocabulary in use and which provides possible sequences of word sub-units. The acoustic reference models correspond to hidden Markov models. The language model 55 provides N-gram probabilities. In particular, a bigram or trigram language model is used. Further particulars on the arrangement of this speech recognition system may be obtained, for example, from WO 99/18556, the contents of which are to be regarded as included in the present patent application herewith.

1. A method for the discriminative adaptation of acoustic reference models of a speech recognition system, wherein, starting from a set of given acoustic speech signals whose corresponding spoken word sequences are known in each case, and starting from given acoustic reference models,
a first scored word sequence is generated for one of the given acoustic speech signals each time through the use of the given acoustic reference models,
if said first word sequence differs from the spoken word sequence, said first word sequence is assigned as an alternative word sequence to the spoken word sequence,
if not, a second scored word sequence is generated for the given acoustic speech signal through the use of the given acoustic reference models, and, provided the difference between the scores of the first and the second word sequence is smaller than a first threshold value, said second word sequence is assigned as an alternative word sequence to the spoken word sequence,
an adaptation of at least one of the given acoustic reference models is carried out with the use of the assignation/assignations thus determined.

2. A method for the discriminative adaptation of acoustic reference models of a speech recognition system as claimed in claim 1, characterized in that the assignations belonging to those given acoustic speech signals whose first word sequence is identical with the spoken word sequence and whose difference between the scores of their first and second word sequences is greater than or equal to the first threshold value are not used for the adaptation of any of the given acoustic reference models.

3. A method for the discriminative adaptation of acoustic reference models of a speech recognition system as claimed in claim 1 or 2, characterized in that those speech signals from among the quantity of given acoustic speech signals are excluded of which the first word sequence is identical with the spoken word sequence and of which the difference between the scores of their first and second word sequences is greater than or equal to a second threshold value, and in that a new quantity of given acoustic speech signals is formed in this manner which takes the place of the old quantity of given acoustic speech signals.

4. A method for the discriminative adaptation of acoustic reference models of a speech recognition system as claimed in any one of the claims 1 to 3, characterized in that a first given quantile of the statistical distribution of the differences between the scores of the first and second word sequences of those given acoustic speech signals of which the first word sequence is identical with the spoken word sequence is used as the first threshold value.

5. A method for the discriminative adaptation of acoustic reference models of a speech recognition system as claimed in any one of the claims 3 and 4, characterized in that a second given quantile of the statistical distribution of the differences between the scores of the first and second word sequences of those given acoustic speech signals of which the first word sequence is identical with the spoken word sequence is used as the second threshold value.

6. A method for the discriminative adaptation of acoustic reference models of a speech recognition system, wherein a method as claimed in any one of the claims 1 to 5 is repeatedly implemented until a stop criterion is reached.

7. A method for the discriminative adaptation of acoustic reference models of a speech recognition system, wherein, starting from a set of given acoustic speech signals whose corresponding spoken word sequences are known or estimated in each case, and starting from given acoustic reference models,
a first scored word sequence is generated for one of the given acoustic speech signals each time through the use of the given acoustic reference models,
if said first word sequence differs from the known or estimated word sequence, said first word sequence is assigned as an alternative word sequence to the known or estimated word sequence,
if not, a second scored word sequence is generated for the given acoustic speech signal through the use of the given acoustic reference models, and, provided the difference between the scores of the first and the second word sequence is smaller than a first threshold value, said second word sequence is assigned as an alternative word sequence to the known or estimated word sequence,
an adaptation of at least one of the given acoustic reference models is carried out with the use of the assignation/assignations thus determined.

8. Acoustic reference models of a speech recognition system which are generated through the use of a method as claimed in any one of the claims 1 to 7.

9. A data carrier with acoustic reference models of a speech recognition system as claimed in claim 8.

10. A speech recognition system with acoustic reference models as claimed in claim 8.

11. A method for the discriminative adaptation of reference models of a pattern recognition system wherein, starting from a quantity of given patterns whose classification is known in each case or is estimated, and starting from given reference models,
a first scored classification is generated for one of the given patterns through the use of the given reference models,
if said first classification differs from the known or estimated classification, said first classification is assigned as an alternative classification to the known or estimated classification,
if not, a second scored classification is generated for the given pattern with the use of the given reference models and, provided the difference between the scores of the first and second classifications is smaller than a first threshold value, said second classification is assigned as an alternative classification to the known or estimated classification,
an adaptation of at least one of said given reference models is carried out with the use of the assignation/assignations thus determined.

12. Reference models of a pattern recognition system which are generated through the use of a method as claimed in claim 11.

13. A data carrier with reference models of a pattern recognition system as claimed in claim 12.

14. A pattern recognition system with reference models as claimed in claim 12.
